(19) United States
(12) Patent Application Publication
(10) Pub. No.: US 2025/0105952 A1
(43) Pub. Date: Mar. 27, 2025

(54) METHOD OF SELECTING A DATA TRANSMISSION METHOD AND METHOD OF OPERATING A COMMUNICATION SYSTEM

(71) Applicant: SEW-EURODRIVE GMBH & CO. KG, Bruchsal (DE)

(72) Inventors: Eike LYCZKOWSKI, Bruchsal (DE); Tobias WEBER, Karlsruhe (DE)

(73) Assignee: SEW-EURODRIVE GMBH & CO. KG, Bruchsal (DE)

(21) Appl. No.: 18/727,733

(22) PCT Filed: Dec. 12, 2022
(86) PCT No.: PCT/EP2022/085456

§ 371 Date: Jul. 10, 2024

(30) Foreign Application Priority Data
Jan. 12, 2022 (DE) 10 2022 000 112.8

(51) Int. Cl. H04L 1/20; H04L 1/00

(52) U.S. Cl. CPC H04L 1/203; H04L 1/0016

(57) ABSTRACT

In a method for selecting a data transmission method from a number of available data transmission methods in a communication system, in which the communication system includes at least a first base station, a second base station, and a terminal device, in which a wireless communication link exists between the first base station and the terminal device via a first radio channel, and in which a wireless communication link exists between the second base station and the terminal device via a second radio channel, a data packet to be transmitted is sent from the terminal device via the first radio channel to the first base station and via the second radio channel to the second base station, at least one value pair is specified that includes a decorrelation distance of a first noise of the first radio channel and a cross-correlation coefficient between the first noise of the first radio channel and a second noise of the second radio channel, a packet error rate is determined for each of the available data transmission methods for the specified value pair, and the data transmission method that has an optimum packet error rate is selected and assigned to the specified value pair.

### FIELD OF THE INVENTION

The present invention relates to a method for selecting a data transmission method from a number of available data transmission methods in a communication system. The present invention also relates to a method for operating a communication system.

### BACKGROUND INFORMATION

A communication system includes a plurality of base stations and terminal devices between which wireless communication links exist via radio channels. Certain conventional communication systems are based on the 5G mobile communications standard, for example, which is also used in modern mobile networks, for example. In such a communication system, data packets to be transmitted are sent from a transmitter to two receivers via two separate radio channels, which is also referred to as packet duplication.

The quality of data transmission via the individual radio channels varies. The quality of data transmission can be described, for example, in the form of a packet error rate. The packet error rate is determined, for example, as the ratio of data packets not received or received incorrectly in a defined period of time to the total number of data packets sent.

In such a communication system, different data transmission methods exist, which include different types of packet duplication as well as different types of modulation methods and coding methods. The quality of data transmission via the radio channels can be improved by selecting a suitable data transmission method.

European Patent Document No. 2 645 474 describes a communication system for data transmission between a plurality of transmission units and user devices. Data is transmitted via radio signals with different polarizations.

A method for selecting a data transmission method in a wireless communication system is described in U.S. Patent Application Publication No. 2021/0022073. For example, the data transmission method that has an optimum packet error rate is selected.

### SUMMARY

Example embodiments of the present invention provide a method for selecting a data transmission method in a communication system, as well as a method for operating a communication system.

According to example embodiments, method for selecting a data transmission method from a number of available data transmission methods in a communication system is provided. The communication system includes a first base station, a second base station, and a terminal device, a wireless communication link exists between the first base station and the terminal device via a first radio channel, a wireless communication link exists between the second base station and the terminal device via a second radio channel, and a data packet to be transmitted is sent from the terminal device via the first radio channel to the first base station and via the second radio channel to the second base station.

For example, at least one value pair is specified, which includes a decorrelation distance of a first noise of the first radio channel and a cross-correlation coefficient between the first noise of the first radio channel and a second noise of the second radio channel. A packet error rate is determined for each of the available data transmission methods for the specified value pair. The data transmission method that has an optimum packet error rate is selected and assigned to the specified value pair. The optimum packet error rate depends on the respective application and is, for example, 10-1 for broadband applications, such as mobile radio and, for example, between 10-3 and 10-7 for industrial applications.

The first noise of the first radio channel has an autocorrelation that can be described by an autocorrelation coefficient. The autocorrelation coefficient is a measure of the similarity of a signal, e.g., the first noise, with itself in a temporal shift. The decorrelation distance is a temporal shift at which the autocorrelation coefficient has dropped to 1/e. The cross-correlation coefficient is a measure of the similarity between a first signal, e.g., the first noise of the first radio channel, and a second signal, e.g., the second noise of the second radio channel.

The method described herein allows for the selection of a suitable data transmission method and the transmission of data packets via the selected data transmission method. During the transmission of data packets, the packet error rate is optimized, e.g., minimized. This significantly improves the quality of data transmission and increases the efficiency of the communication system.

According to example embodiments, for the specified value pair, the packet error rate for each of the available data transmission methods is determined by a simulator. The simulator allows a comprehensive examination of many possible value pairs.

According to example embodiments, the packet error rate is determined by the simulator by specifying a first partial noise caused by multipath propagation, a second partial noise caused by obstacles, a third partial noise caused by other transmitters, and a signal strength drop over a distance of the radio channel. A signal-to-noise ratio is calculated from a useful signal strength and the partial noises and the signal strength drop. The packet error rate is taken from a table that describes the relationship between signal-to-noise ratio and packet error rate.

For example, the signal-to-noise ratio is calculated as the difference between the signal strength and the partial noises as well as the signal strength drop. For example, the signal-to-noise ratio is calculated as the ratio of the power of the signal strength to the power of the partial noises and the signal strength drop. The third partial noise, which is caused by other transmitters, is represented by a Gaussian distribution in which the standard deviation, and thus the strength of the noise, can be indicated. The first partial noise caused by multipath propagation is rayleigh-distributed in the linear range. The second partial noise, which is caused by obstacles, is normally distributed on a dB scale.

The partial noises are specified by creating autocorrelated, normally distributed and/or rayleigh-distributed arrays by superimposing cosine oscillations and sine oscillations. A decorrelation distance is set for normally distributed arrays using a formula from the literature and for rayleigh-distributed arrays using the highest value of the input array. The standard deviation of the distributions can be set. This allows the noise level to be determined. When creating respectively correlated arrays, the random parameters are saved when the first array is created. For the correlated array, a uniform distribution is placed over the saved random parameters and the random parameters for the correlated array are generated from this distribution. The correlation coefficient can be set via the width of the uniform distribution. The noise values are saved as elements in arrays. Each element represents the noise of a time step. The decorrelation distance corresponds to an element in the array at which the autocorrelation function has dropped to 1/e.

According to example embodiments, a plurality of value pairs is specified, each including a decorrelation distance of a first noise of the first radio channel and a cross-correlation coefficient between the first noise of the first radio channel and a second noise of the second radio channel. For each specified value pair, a packet error rate is respectively determined for each of the available data transmission methods, and the data transmission method that has the optimum packet error rate is selected and assigned to the specified value pair. This means that the suitable data transmission method can be selected depending on the current properties of the first noise and the second noise of the radio channels.

According to example embodiments, for each specified value pair, the decorrelation distance, the cross-correlation coefficient, and the respectively assigned data transmission method are saved in a table. The table is formed in the shape of a three-dimensional array or characteristic map.

For example, the number of available data transmission methods includes a plurality of different types of packet duplication. In one type of packet duplication, the data packet to be transmitted is sent from the terminal device to the first base station via a first carrier frequency via the first radio channel, for example, and sent to the second base station via a second carrier frequency, which is different from the first carrier frequency, via the second radio channel. In another type of packet duplication, the data packet to be transmitted is sent from the terminal device to the first base station via the first radio channel at a first time, for example, and sent to the second base station via the second radio channel at a second time, which is different from the first time.

For example, the number of available data transmission methods includes a plurality of different types of modulation. The different types of modulation relate to the necessary signal-to-noise ratio and possible data transmission in a time slot. In 5G, for example, the modulation methods and coding methods in the standard are defined depending on the signal quality.

According to example embodiments, at least one additional value pair is specified, which includes a decorrelation distance of the second noise of the second radio channel and a cross-correlation coefficient between the first noise of the first radio channel and the second noise of the second radio channel. A packet error rate is determined for each of the available data transmission methods for the specified additional value pair. The data transmission method that has the optimum packet error rate is selected and assigned to the specified additional value pair. For example, it is not necessary to take into account the decorrelation distance of the second noise of the second radio channel. For example, the second noise is similar to the first noise. However, taking into account the decorrelation distance of the second noise of the second radio channel may improve the quality of data transmission and the efficiency of the communication system.

A method for operating a communication system is also described herein. The communication system includes a first base station, a second base station, and a terminal device, a wireless communication link exists between the first base station and the terminal device via a first radio channel, a wireless communication link exists between the second base station and the terminal device via a second radio channel, and a data packet to be transmitted is sent from the terminal device via the first radio channel to the first base station and via the second radio channel to the second base station.

A data transmission method is selected from a number of available data transmission methods using the method for selecting a data transmission method described herein. The data packet to be transmitted is sent from the terminal device via the first radio channel to the first base station and via the second radio channel to the second base station using the selected data transmission method.

The method permits a transmission of data packets, in which the packet error rate is optimized, e.g., minimized. This significantly improves the quality of data transmission and increases the efficiency of the communication system.

According to example embodiments, a first noise of the first radio channel is measured, and a second noise of the second radio channel is measured. A decorrelation distance of the measured first noise of the first radio channel is calculated, a cross-correlation coefficient between the measured first noise of the first radio channel and the measured second noise of the second radio channel is calculated, and the data transmission method is selected which is assigned in a previously created table to the value pair whose decorrelation distance corresponds to the calculated decorrelation distance and whose cross-correlation coefficient corresponds to the calculated cross-correlation coefficient. The table is formed in the shape of a three-dimensional array or characteristic map. The measurement of the first noise of the first radio channel and the second noise of the second radio channel with the calculation of the decorrelation distance and the cross-correlation coefficient makes it possible to select a data transmission method under the respectively current conditions.

Further features and aspects of example embodiments of the present invention are explained in more detail below with reference to the appended schematic FIGURE.

### BRIEF DESCRIPTION OF THE DRAWING

FIG. 1 schematically illustrates a communication system.

### DETAILED DESCRIPTION

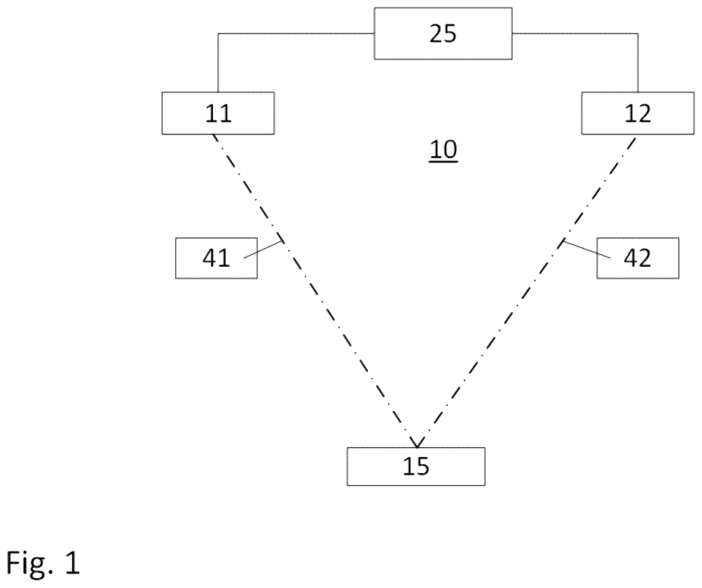

FIG. 1 schematically illustrates a communication system 10. The communication system 10 is based on the 5G mobile communications standard, which is also used in modern mobile networks, for example. For example, the communication system 10 includes a first base station 11, a second base station 12, a core network 25, and a terminal device 15.

For example, the first base station 11 and the second base station 12 are stationary and spatially arranged at a distance from each other. It is also possible that the base stations 11, 12 are arranged adjacent to each other. The base stations 11, 12 are connected to the core network 25. The core network 25 is a data network, which, for example, is wired. The base stations 11, 12 each have a communication unit for data transmission. The communication units each include an antenna.

The terminal device 15 is mobile, for example, and is arranged, for example, as a vehicle or a cell phone. The terminal device 15 is thus movable relative to the base stations 11, 12. The end device 15 also has a communication unit for data transmission. The communication unit of the terminal device 15 also includes an antenna.

A wireless communication link exists between the first base station 11 and the terminal device 15 via a first radio channel 41. A wireless communication link exists between the second base station 12 and the terminal device 15 via a second radio channel 42. The antennas of the communication units of the base stations 11, 12 and the terminal device 15 are used for data transmission via the radio channels 41, 42.

A data packet to be transmitted by the terminal device 15 is sent by the terminal device 15 via the first radio channel 41 to the first base station 11 and via the second radio channel 42 to the second base station 12. The data packet to be transmitted is thus sent from the terminal device 15 as a transmitter via two separate radio channels 41, 42 to two base stations 11, 12 as receivers. This type of data transmission is also referred to as packet duplication.

First, a plurality of value pairs is specified, each including a decorrelation distance of a first noise of the first radio channel (41) and a cross-correlation coefficient between the first noise of the first radio channel (41) and a second noise of the second radio channel (42). The decorrelation distances and the cross-correlation coefficients are saved in a table.

A packet error rate is determined by a simulator for each of the available data transmission methods for each specified value pair. The data transmission method that has the optimum packet error rate is respectively selected and assigned to the specified value pair. The optimum packet error rate, for example, is the lowest packet error rate. For example, the packet error rate is defined as the ratio of data packets not received or received incorrectly in a defined period of time to the total number of data packets sent. The data transmission method respectively assigned to the specified value pair is also saved in the table.

During operation of the communication system, a first noise of the first radio channel (41) is measured, and a second noise of the second radio channel (42) is measured. A decorrelation distance of the measured first noise of the first radio channel (41) is calculated, and a cross-correlation coefficient between the measured first noise of the first radio channel (41) and the measured second noise of the second radio channel (42) is calculated.

The data transmission method is selected which is assigned in the previously created table to the value pair whose decorrelation distance corresponds to the calculated decorrelation distance and whose cross-correlation coefficient corresponds to the calculated cross-correlation coefficient. Data packets to be transmitted are sent from the terminal device (15) via the first radio channel (41) to the first base station (11) and via the second radio channel (42) to the second base station (12) using the previously selected data transmission method.

### LIST OF REFERENCE NUMERALS

10 Communication system
11 First base station
12 Second base station
15 Terminal device
25 Core network
41 First radio channel
42 Second radio channel

1-10. (canceled)

11. A method for selecting a data transmission method from a number of available data transmission methods in a communication system that includes a first base station, a second base station, a terminal device, a wireless communication link between the first base station and the terminal device via a first radio channel, and a wireless communication link between the second base station and the terminal device via a second radio channel, the first radio channel adapted to send a data packet to be transmitted from the terminal device to the first base station, the second radio channel adapted to send the data packet to be transmitted from the terminal device to the second base station, comprising:
specifying at least one value pair that includes a decorrelation distance of a first noise of the first radio channel and a cross-correlation coefficient between the first noise of the first radio channel and a second noise of the second radio channel;
determining a packet error rate for each available data transmission method for the specified value pair; and
selecting the data transmission method that has an optimum packet error rate and assigning the selected data transmission method to the specified value pair.

12. The method according to claim 11, wherein, for the specified value pair, the packet error rate for each available data transmission method is determined by a simulator.

13. The method according to claim 12, wherein the packet error rate is determined by the simulator by specifying a first partial noise caused by multipath propagation, a second partial noise caused by obstacles, a third partial noise caused by other transmitters, and a signal strength drop over a distance of the radio channel, a signal-to-noise ratio is calculated from a useful signal strength and the partial noises and the signal strength drop, and the packet error rate is obtained from a table that describes a relationship between signal-to-noise ratio and packet error rate.

14. The method according to claim 11, wherein a plurality of the value pairs is specified, for each specified value pair, a respective packet error rate is determined for each available data transmission method, and the data transmission method that has the optimum packet error rate is selected and assigned to each respective specified value pair.

15. The method according to claim 14, wherein, for each specified value pair, the decorrelation distance, the cross-correlation coefficient, and the respectively assigned data transmission method are saved in a table.

16. The method according to claim 11, wherein the number of available data transmission methods includes a plurality of different types of packet duplication.

17. The method according to claim 11, wherein the number of available data transmission methods includes a plurality of different types of modulation.

18. The method according to claim 11, wherein at least one additional value pair is specified that includes a decorrelation distance of the second noise of the second radio channel and a cross-correlation coefficient between the first noise of the first radio channel and the second noise of the second radio channel, for the specified additional value pair, a packet error rate is determined for each available data transmission method, and the data transmission method that has the optimum packet error rate is selected and assigned to the specified additional value pair.

19. The method according to claim 11, wherein the communication system is arranged as a 5G mobile communication system.

20. The method according to claim 11, wherein the first base station and the second base station are stationary and are spatially separated from each other.

21. The method according to claim 11, wherein the first base station and the second base station are connected to each other by a core network.

22. The method according to claim 21, wherein the core network is arranged as a wired network.

23. The method according to claim 11, wherein the terminal device is movable relative to the first base station and the second base station.

24. The method according to claim 11, wherein the terminal device is arranged as a mobile device.

25. A method for selecting a data transmission method from a number of available data transmission methods in a communication system that includes a first base station, a second base station, a terminal device, a wireless communication link between the first base station and the terminal device via a first radio channel, and a wireless communication link between the second base station and the terminal device via a second radio channel, comprising:
sending a data packet to be transmitted from the terminal device via the first radio channel to the first base station and via the second radio channel to the second base station;
specifying at least one value pair that includes a decorrelation distance of a first noise of the first radio channel and a cross-correlation coefficient between the first noise of the first radio channel and a second noise of the second radio channel;
determining a packet error rate for each available data transmission method for the specified value pair; and
selecting the data transmission method that has an optimum packet error rate and assigning the selected data transmission method to the specified value pair.

26. A method for operating a communication system that includes a first base station, a second base station, a terminal device, a wireless communication link between the first base station and the terminal device via a first radio channel, and a wireless communication link between the second base station and the terminal device via a second radio channel, the first radio channel adapted to send a data packet to be transmitted from the terminal device to the first base station, the second radio channel adapted to send the data packet to be transmitted from the terminal device to the second base station, comprising:
selecting a data transmission method from a number of available data transmission methods; and
sending the data packet to be transmitted from the terminal device via the first radio channel to the first base station and via the second radio channel to the second base station using the selected data transmission method.

27. The method according to claim 26, further comprising:
measuring a first noise of the first radio channel;
measuring a second noise of the second radio channel;
calculating a decorrelation distance of the measured first noise of the first radio channel; and
calculating a cross-correlation coefficient between the measured first noise of the first radio channel and the measured second noise of the second radio channel;
wherein the data transmission method is selected that is assigned in a previously created table to a value pair whose decorrelation distance corresponds to the calculated decorrelation distance and whose cross-correlation coefficient corresponds to the calculated cross-correlation coefficient.

28. The method according to claim 26, wherein the first base station and the second base station are stationary and are spatially separated from each other.

29. The method according to claim 26, wherein the terminal device is movable relative to the first base station and the second base station.

30. The method according to claim 26, wherein the terminal device is arranged as a mobile device.
